(19) United States
(12) Patent Application Publication
(10) Pub. No.: US 2018/0345550 A1
(43) Pub. Date: Dec. 6, 2018

(54) PRODUCTION METHOD FOR COVER

(71) Applicant: JTEKT CORPORATION, Osaka-shi, Osaka (JP)

(72) Inventors: Yoichiro SANKAI, Kashiwara-shi (JP); Teruyuki WAKISAKA, Nagoya-shi (JP); Akihiro TAKEUCHI, Kashiba-shi (JP)

(73) Assignee: JTEKT Corporation, Osaka-shi, Osaka (JP)

(21) Appl. No.: 15/775,698

(22) PCT Filed: Nov. 10, 2016
(86) PCT No.: PCT/JP2016/083313

§ 371 Date: May 11, 2018

(30) Foreign Application Priority Data
Nov. 13, 2015 (JP) 2015-223008

(51) Int. Cl. B29C 45/14; B29C 45/26; B29C 33/12

(52) U.S. Cl. CPC B29C 45/14065; B29C 45/26; B29L 2031/32; B29C 2045/14122; B29C 33/12

(57) ABSTRACT

A production method for a cover attached to an outer ring of a hub unit first prepares a first mold and a second mold which form a cavity filled with a resin material. Next, by a protrusion of the first mold, a nut is supported. Next, when viewed from an axial direction of the nut, in a state where at least a part of the gate of the second mold overlaps an inside of the nut as compared with an outer circumferential surface of the nut, the first mold and the second mold are die-matched. Then, a resin material is injected into the cavity.

### TECHNICAL FIELD

One aspect of the present invention relates to a production method for a cover attached to a hub unit.

### BACKGROUND ART

A hub unit is used to rotatably attach wheels of a vehicle to a suspension. In addition, in a vehicle having an anti-lock braking system (ABS), a sensor for detecting the rotational speed of the wheel is attached to the hub unit.

JP-A-2013-155881 discloses a sensor cap for attaching the above-described sensor to a hub unit. The sensor cap includes a cap main body and a core bar. The cap main body is formed by injection molding a synthetic resin. The core bar is molded in an opening portion of the cap main body. The cap main body is formed with an attachment portion which protrudes in an axial direction. An insertion hole which extends in the axial direction is formed in the attachment portion. A sensor unit is mounted in the insertion hole. A nut is embedded in the attachment portion. The sensor unit is fixed to the attachment portion via a fixing bolt attached to the nut.

### PRIOR ART DOCUMENT(S)

### Patent Document(s)

Patent Document 1: JP-A-2013-155881

### SUMMARY OF THE INVENTION

### Problem to be Solved by the Invention

In JP-A-2013-155881, a nut is embedded in an attachment portion. Therefore, when producing the sensor cap, it is necessary to dispose the nut at a predetermined position in the mold. When the nut is disposed in the mold, there is a concern that the position of the nut is shifted due to the resin material injected into the mold. Here, it is necessary to fix the nut such that the position of the nut does not shift. As a mechanism for fixing the nut, it is considered, for example, to insert the support member into the hole of the nut and to press the nut in a direction opposite to the direction in which the support member is inserted. As a member for pressing the nut, for example, a pin disposed to be capable of advancing and retracting toward the nut can be considered. In a case of using the pin disposed so as to be capable of advancing and retracting, it is preferable to release the pin from the nut immediately after the resin material is injected. Accordingly, a part of the nut that was pressed by the pin can also be covered with the resin.

As described above, in a case where the nut is pressed by the pin disposed so as to be capable of advancing and retreating, the nut can be fixed. However, it is necessary to provide a mechanism for driving the pins in the mold. As a result, the structure of the mold becomes complicated.

An object of one aspect of the present invention is to avoid complicating a mold used in producing a cover attached to a hub unit.

### Means for Solving the Invention

An embodiment of the present invention provides a production method for a cover to be attached to an outer ring of a hub unit, comprising: preparing a first mold comprising a protrusion which protrudes into a first recess portion that forms a part of a cavity to be filled with a resin material; preparing a second mold comprising a gate which is opened into a second recess portion that forms another part of the cavity, and through which the resin material with which the cavity is filled passes; supporting a nut by the protrusion; die-matching the first mold and the second mold in a state where at least a part of the gate overlaps an inside of the nut as compared with an outer circumferential surface of the nut when viewed from an axial direction of the nut; and injecting a resin material into the cavity which is formed in a state where the first mold and the second mold are die-matched.

### Advantage of the Invention

According to the production method for cover according to the embodiment of the present invention, complication of the mold can be avoided.

### BRIEF DESCRIPTION OF THE DRAWINGS

FIG. 1 is a sectional view illustrating a hub unit to which a cover produced by a production method for a cover according to an embodiment of the present invention is attached.

FIG. 2 is a sectional view of the cover.

FIG. 3A is a sectional view illustrating the production method for a cover, and is a sectional view illustrating a state where a nut and a core bar are disposed in a cavity formed in a mold.

FIG. 3B is a sectional view illustrating the production method for a cover, and is a sectional view illustrating a state where a resin material is injected into the mold.

FIG. 4 is a sectional view illustrating an enlarged part of FIG. 3A.

FIG. 5 is a sectional view illustrating a state where the resin material is injected toward the nut.

FIG. 6 is a sectional view illustrating a state where a nut different from the nut illustrated in FIG. 2 is supported by a protrusion formed in the mold.

### MODE FOR CARRYING OUT THE INVENTION

A production method for a cover according to an embodiment of the present invention is a production method for a cover to be attached to an outer ring of a hub unit. The production method includes the following step (A), step (B), step (C), step (D), and step (E). In step (A), a first mold having a protrusion which protrudes into a first recess portion that forms a part of a cavity to be filled with a resin material is prepared. In step (B), a second mold having a gate which opens into a second recess portion that forms another part of the cavity and through which the resin material with which the cavity is filled passes, is prepared. In step (C), a nut is supported by the protrusion formed in the first mold. In step (D), when viewed from the axial direction of the nut, in a state where at least a part of the gate overlaps an inside of the nut as compared with an outer circumferential surface of the nut, the first mold and the second mold die are die-matched. In step (E), a resin material is injected into a cavity formed in a state where the first mold and the second mold are die-matched.

In the above-described production method, the nut can be pressed by the resin material injected from the gate. Therefore, similar to the related art, it is unnecessary to press the nut with a pin disposed so as to be capable of advancing and retracting toward the nut. As a result, complication of the structure of the mold can be avoided.

In addition, in the above-described production method, the nut includes not only that in which screw grooves are formed on the inner circumferential surface of the hole into which the bolt is inserted before the resin material is injected, but also that in which screw grooves are formed on the inner circumferential surface of the hole into which the bolt is inserted after the resin material is injected.

Preferably, the nut includes a cylindrical section and a stopper. Bolts are inserted into the cylindrical section. The stopper covers the opening on the one axial end of the cylindrical section and comes into contact with the bolt inserted into the cylindrical section, and accordingly, the insertion amount of the bolt is specified.

In this case, in the nut, it is possible to ensure an area which is in contact with the resin material injected from the gate. Therefore, it is easy to hold the nut with the resin material injected from the gate.

Preferably, an opening of the gate to the cavity overlaps the stopper when viewed in the axial direction of the nut. In this case, when pressing the nut with the resin material injected from the gate, it becomes difficult for the nut to be shaken in a direction intersecting with the axial direction.

Preferably, the opening of the gate to the cavity entirely overlaps the stopper when viewed in the axial direction of the nut. In this case, when pressing the nut with the resin material injected from the gate, it becomes difficult for the nut to be shaken in a direction intersecting with the axial direction.

Preferably, the center of the opening of the gate to the cavity matches the center of the stopper when viewed in the axial direction of the nut. In this case, when pressing the nut with the resin material injected from the gate, it becomes difficult for the nut to be shaken in a direction intersecting with the axial direction.

Hereinafter, embodiments of the present invention will be described with reference to the drawings. The same or corresponding parts in the drawings will be given the same reference numerals, and the description thereof will not be repeated.

### Embodiment

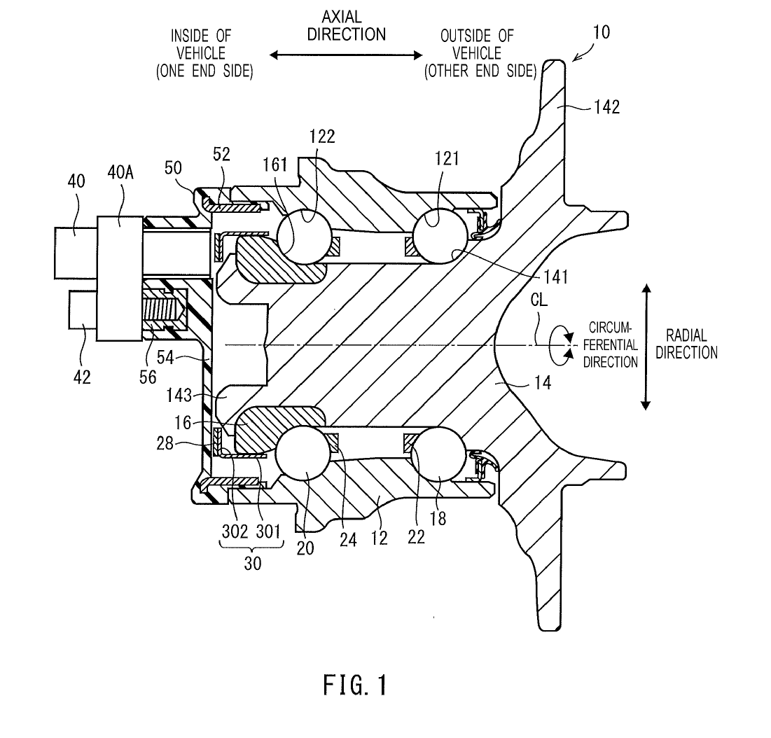

FIG. 1 illustrates a hub unit 10 to which the cover produced by the production method according to an embodiment of the present invention is attached. In addition, in the following description, an axial direction is a direction in which the center shaft line CL of the hub unit 10 extends. The radial direction is a direction perpendicular to the center shaft line CL, that is, a direction perpendicular to the axial direction. The circumferential direction is a direction around the center shaft line CL. In a state where the hub unit 10 is disposed in a vehicle, one axial end side (left end side in FIG. 1) of the hub unit 10 corresponds to the inside of the vehicle, and the other axial end side of the hub unit 10 (right end side in FIG. 1) corresponds to the outside of the vehicle.

1. Hub Unit

With reference to FIG. 1, the hub unit 10 includes an outer ring 12, an inner shaft 14, an inner ring 16, a plurality of rolling elements 18, a plurality of rolling elements 20, a retainer 22, and a retainer 24. Hereinafter, the members will be described.

The outer ring 12 has a cylindrical shape. On the inner circumferential surface of the outer ring 12, two raceway surfaces 121 and 122 are formed. The outer ring 12 is, for example, fixed to a suspension.

The inner shaft 14 is disposed on the inside of the outer ring 12 and positioned coaxially to the outer ring 12. The inner shaft 14 is disposed so as to be rotatable in the circumferential direction with respect to the outer ring 12.

The inner shaft 14 has a raceway surface 141. The raceway surface 141 is formed on the outer circumferential surface of the inner shaft 14.

The inner shaft 14 further includes a flange 142. The flange 142 is formed continuously in the circumferential direction.

A plurality of holes are formed in the flange 142. The plurality of holes are positioned at equivalent intervals in the circumferential direction, for example. Wheels, brake discs, and the like are attached to the inner shaft 14 by bolts inserted into each of the plurality of holes.

The inner wheel 16 has a cylindrical shape. The inner ring 16 is fixed to the inner shaft 14. Specifically, in a state where the inner shaft 14 is press-fitted to the inner ring 16, the inner ring 16 is caulked and fixed to the inner shaft 14 by a caulking portion 143 formed at a left end (one axial end) of the inner shaft 14.

The inner ring 16 includes a raceway surface 161. The raceway surface 161 is formed on the outer circumferential surface of the inner wheel 16.

The plurality of rolling elements 18 are disposed between the outer ring 12 and the inner shaft 14. The plurality of rolling elements 18 are disposed at equivalent intervals in the circumferential direction by the retainer 22. Each of the plurality of rolling elements 18 comes into contact with the raceway surface 121 and the raceway surface 141.

The plurality of rolling elements 20 are disposed between the outer ring 12 and the inner ring 16. The plurality of rolling elements 20 are disposed at equivalent intervals in the circumferential direction by the retainer 24. Each of the plurality of rolling elements 20 comes into contact with the raceway surface 122 and the raceway surface 161.

2. Pulser Ring

In the hub unit 10, a pulser ring 28 is fixed to the inner ring 16 via the core bar 30.

The core bar 30 includes a cylindrical section 301 and an annular plate portion 302. The cylindrical section 301 has a cylindrical shape. At the left end (one axial end) of the cylindrical section 301, an annular plate portion 302 is disposed. The annular plate portion 302 has an annular plate shape. An outer circumferential edge of the annular plate portion 302 is formed integrally with the left end (one axial end) of the cylindrical section 301.

The pulser ring 28 is fixed to one surface in the thickness direction of the annular plate portion 302 (the end surface on the left side in FIG. 1). As a method of fixing the pulser ring 28 to the annular plate 302, for example, there is a case where adhesion is performed. In the pulser ring 28, N poles and S poles are alternately magnetized in the circumferential direction.

3. Cover

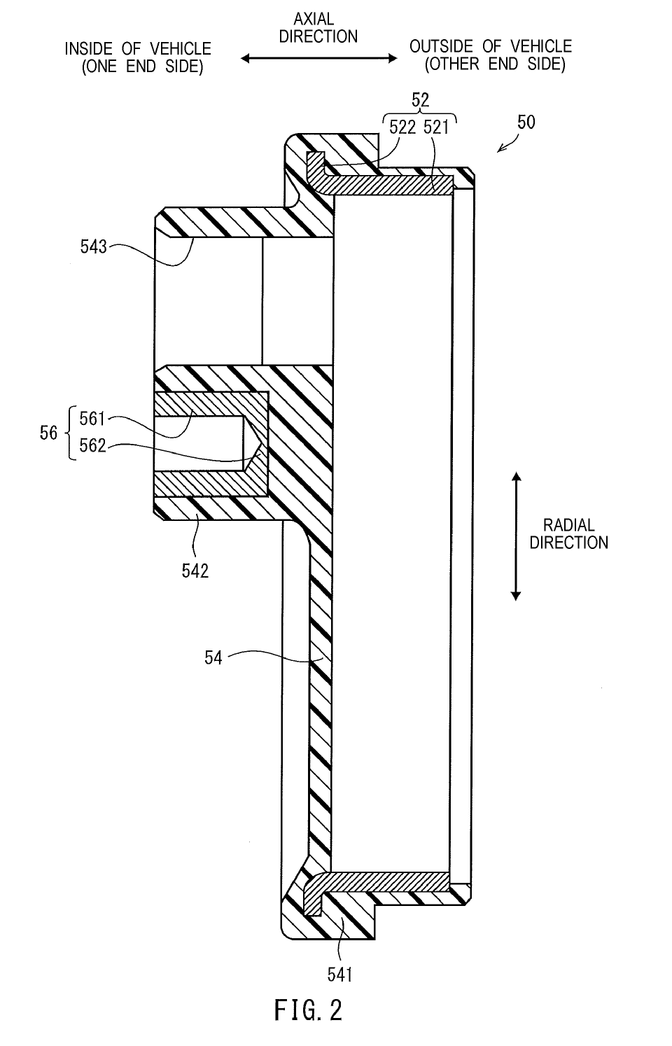

A cover 50 is fixed to the hub unit 10. The cover 50 will be described with reference to FIG. 2. The cover 50 includes a core bar 52, a cover main body 54, and a nut 56.

The core bar 52 is formed of a metal. The core bar 52 includes a cylindrical section 521 and a flange portion 522. The cylindrical section 521 has a cylindrical shape. At the left end (one axial end) of the cylindrical section 521, a flange portion 522 is disposed. The flange portion 522 has an annular plate shape. The inner circumferential edge of the flange portion 522 is formed integrally with the left end (one axial end) of the cylindrical section 521.

The cover main body 54 is disposed at the left end (one axial end) of the cylindrical section 521. The cover main body 54 is formed of a synthetic resin. The cover main body 54 has a disc shape. The outer circumferential edge of the cover main body 54 is connected to the left end (one axial end) of the cylindrical section 521 across the entire circumference. In other words, the cover main body 54 covers the opening at the left end (one axial end) of the cylindrical section 521.

The cover main body 54 includes a covering portion 541. The covering portion 541 is positioned at the outer circumferential edge of the cover main body 54. The covering portion 541 is formed across the entire circumference. The covering portion 541 covers both surfaces (left and right end surfaces in FIG. 2) in a thickness direction of the flange portion 522 across the entire circumference. In other words, the flange portion 522 is buried in the covering portion 541. The covering portion 541 covers the outer circumferential surface of the cylindrical section 521 across the entire circumference.

The cover main body 54 includes an attachment portion 542. The attachment portion 542 protrudes from the cover main body 54 toward the left side (one axial end side). The attachment portion 542 extends in the axial direction with a substantially constant sectional shape.

In the cover main body 54, an insertion hole 543 is formed at a position at which the attachment portion 542 is formed. The insertion hole 543 extends in the axial direction and has a cylindrical inner circumferential surface. The insertion hole 543 is formed to penetrate the cover main body 54 in the axial direction.

In the attachment portion 542, the nut 56 is embedded at a position different from the position at which the insertion hole 543 is formed. The nut 56 includes a cylindrical section 561 and a stopper 562.

The cylindrical section 561 has a cylindrical shape. A screw groove is formed on the inner circumferential surface of the cylindrical section 561. In a state where the nut 56 is embedded in the attachment portion 542, the left end surface (one axial end surface) of the cylindrical section 561 is exposed. In other words, in a state where the nut 56 is embedded in the attachment portion 542, the left end surface (one axial end surface) of the cylindrical section 561 is not covered with the attachment portion 542.

The stopper 562 is formed at the right end (the other axial end) of the cylindrical section 561. The stopper 562 has a disc shape and regulates the right end (an end on the other axial end side) of the hole of the cylindrical section 561.

4. Production Method for Cover

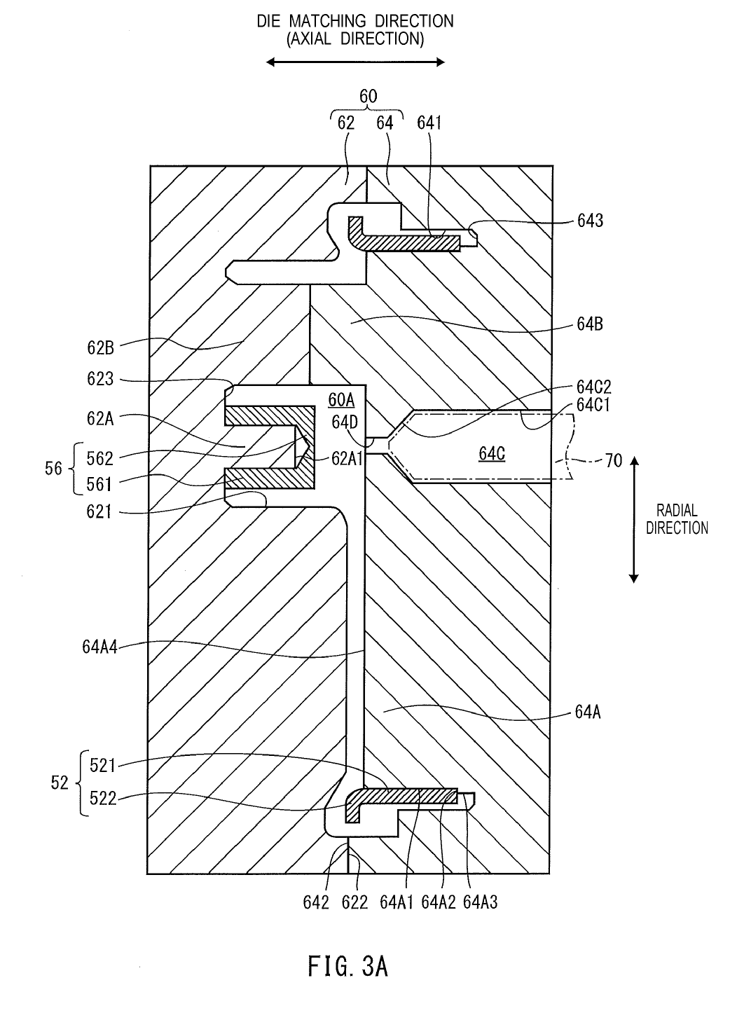

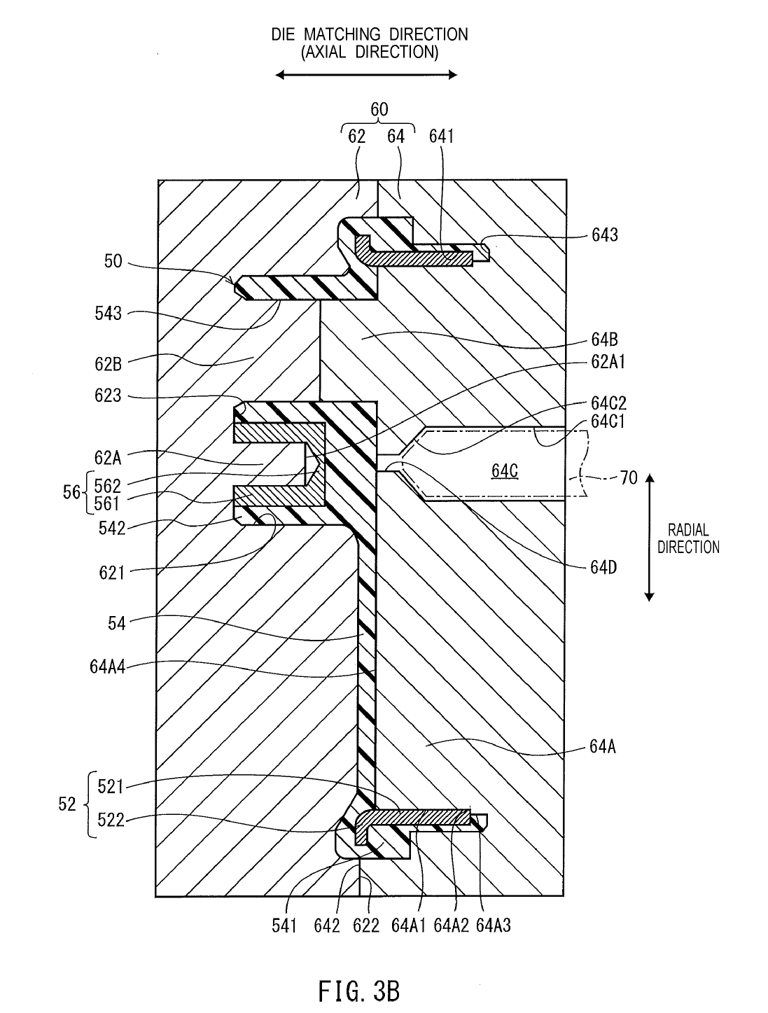

Next, a production method for the cover 50 will be described. First, a mold 60 (refer to FIG. 3A) used for production the cover 50 is prepared. Next, as illustrated in FIG. 3A, the core bar 52 and the nut 56 are disposed in the metal mold 60.

The mold 60 includes a mold 62 that serves as a first mold and a mold 64 that serves as a second mold. By die-matching the mold 62 and the mold 64, a cavity 60A is formed in the mold 60.

Hereinafter, details of the mold 62 and the mold 64 will be described. In addition, in the following description, the leftward-and-rightward direction in the drawing is a die matching direction of the mold 62 and the mold 64.

A recess portion 621 that serves as a first recess portion is formed in the mold 62. The recess portion 621 is open on a die matching surface 622 with the mold 64 in the mold 62. In other words, the recess portion 621 is open toward the mold 64. In short, the recess portion 621 is open in the die matching direction.

In the recess portion 621, an end surface 623 is formed. The end surface 623 is at a position separated the most from the die matching surface 622. The end surface 623 regulates the end of the recess portion 621 in the die matching direction. The end surface 623 has a shape that corresponds to a tip end surface of the attachment portion 542 of the cover 50.

In the recess portion 621, a protrusion 62A and a protrusion 62B are disposed. The protrusion 62A protrudes from the end surface 623 toward the mold 64. In short, the protrusion 62A protrudes in the die matching direction from the end surface 623. The protrusion 62A has a cylindrical shape. In other words, the protrusion 62A extends in the die matching direction with a substantially constant diameter. The protrusion 62A has a rounded tip end surface 62A1.

The protrusion 62A is inserted into the cylindrical section 561 of the nut 56. In the state, the tip end surface of the protrusion 62A is in contact with the stopper 562 of the nut 56.

The protrusion 62B is formed at a position different from the protrusion 62A. The protrusion 62B protrudes from the end surface 623 toward the mold 64. In short, the protrusion 62B protrudes in the die matching direction from the end surface 623. The protrusion 62B has a cylindrical shape. In other words, the protrusion 62B extends in the die matching direction with a substantially constant diameter. The protrusion 62B has a rounded tip end surface. The diameter of the protrusion 62B is greater than the diameter of the protrusion 62A.

A recess portion 641 that serves as a second recess portion is formed in the mold 64. The recess portion 641 is open on a die matching surface 642 with the mold 62 in the mold 64. In other words, the recess portion 641 is open toward the mold 62. In short, the recess portion 641 is open in the die matching direction.

The recess portion 641 has an end surface 643. The end surface 643 is at a position separated the most from the die matching surface 642. In short, the end surface 643 regulates the end of the recess portion 641 in the die matching direction.

In the recess portion 641, a protrusion 64A is disposed. The protrusion 64A protrudes from the end surface 643 toward the mold 62. In short, the protrusion 64A protrudes in the die matching direction from the end surface 643. The protrusion 64A has a cylindrical shape. The protrusion 64A has an outer circumferential surface 64A1, a step surface 64A2, and an outer circumferential surface 64A3.

The outer circumferential surface 64A1 is a cylindrical surface that extends straight in the die matching direction with a substantially constant diameter. The outer circumferential surface 64A3 is a cylindrical surface that extends straight in the die matching direction with a substantially constant diameter. The diameter of the outer circumferential surface 64A3 is greater than the diameter of the outer circumferential surface 64A1. The step surface 64A2 is an annular surface. The inner circumferential end of the step surface 64A2 is connected to the right end of the outer circumferential surface 64A1 (the end which is separated from the mold mating surface 642 in the die matching direction). The outer circumferential end of the step surface 64A2 is connected to the left end of the outer circumference surface 64A3 (the end closer to the die matching surface 642 in the die matching direction).

The protrusion 64A has a tip end surface 64A4. The end surface 64A4 has an annular shape.

In the end surface 64A4, a protrusion 64B is formed. The protrusion 64B protrudes from the tip end surface 64A4 toward the mold 62. In short, the protrusion 64B protrudes in the die matching direction from the tip end surface 64A4. The protrusion 64B has a cylindrical shape. In other words, the protrusion 64B extends in the die matching direction with a substantially constant diameter. The protrusion 64B has a rounded tip end surface. In a state where the mold 62 and the mold 64 are die-matched, the protrusion 64B is positioned coaxially to the protrusion 62B. The tip end surface of the protrusion 64B overlaps the tip end surface of the protrusion 62B.

The protrusion 64A is inserted into the cylindrical section 521 of the core bar 52. In this state, the right end (the other axial end) of the cylindrical section 521 is in contact with the stepped surface 64A2. In other words, an insertion amount of the cylindrical section 521 is regulated by the step surface 64A2.

In the mold 64, an accommodating recess portion 64C is formed. The accommodating recess portion 64C is formed at a position at which the protrusion 64A is formed. The accommodating recess portion 64C is open in a direction opposite to the direction in which the protrusion 64A protrudes. The tip end part of a hot runner nozzle 70 is accommodated in the accommodating recess portion 64C.

The accommodating recess portion 64C has a cylindrical inner circumferential surface 64C1 and a tapered cylindrical inner circumferential surface 64C2. The right end of the inner circumferential surface 64C2 (the end farthest from the die matching surface 642 in the die matching direction) is connected to the left end of the inner circumferential surface 64C1 (the end closest to the die matching surface 642 in the die matching direction). The inner circumferential surface 64C1 extends straight in the die matching direction with a substantially constant diameter. The right end of the inner circumferential surface 64C1 (the end separated from the die matching surface 642 in the die matching direction) regulates an opening end of the accommodating recess portion 64C. The diameter of the inner circumferential surface 64C2 is smaller at the end separated from the inner circumferential surface 64C1 than that at the end connected to the inner circumferential surface 64C1.

In the mold 64, a gate 64D is formed. The gate 64D has a cylindrical inner circumferential surface. In other words, the gate 64D extends straight in the die matching direction with a substantially constant diameter. The right end of the gate 64D (the end separated from the die matching surface 642) is connected to the accommodating recess portion 64C (specifically the small diameter end of the inner circumferential surface 64C2). The left end (the end closer to the die matching surface 642) of the gate 64D is open to the tip end surface 64A4 of the protrusion 64A.

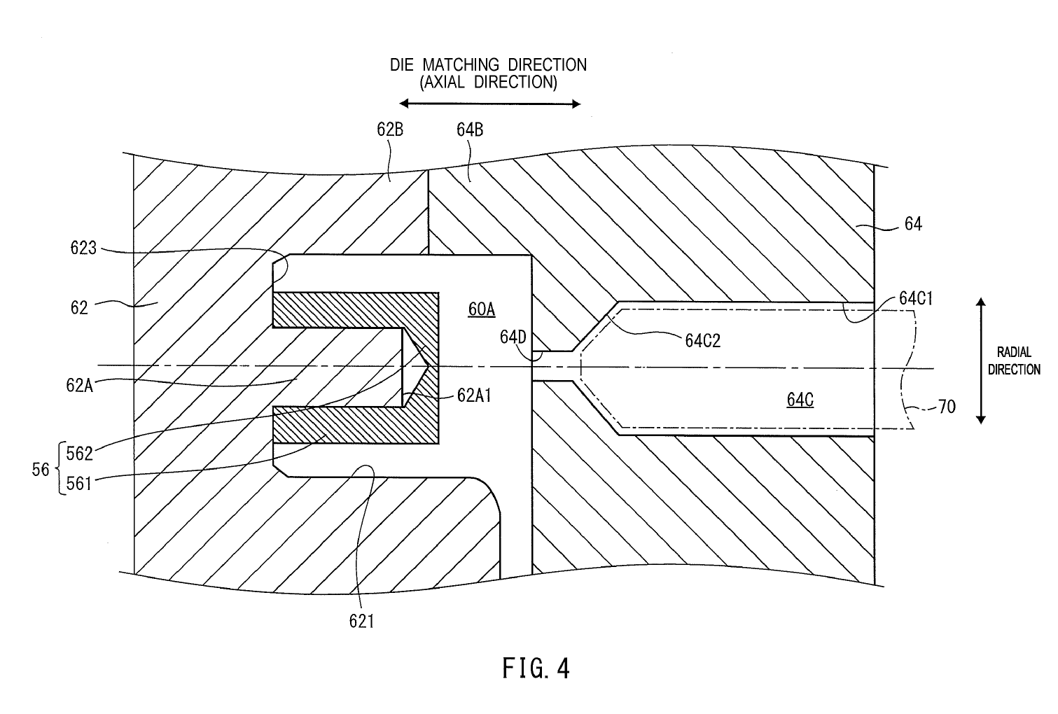

In a state where the mold 62 and the mold 64 are die-matched, as illustrated in FIG. 4, the center (the center in the radial direction) of the gate 64D matches the center (the center in the radial direction) of the protrusion 62A. In other words, the gate 64D is positioned coaxially to the protrusion 62A formed in the mold 62. In a state where the protrusion 62A is inserted in the cylindrical section 561, the center (the center in the radial direction) of the nut 56 matches the center (the center in the radial direction) of the gate 64D. In other words, the gate 64D is positioned coaxially to the nut 56. In short, when viewed from the die matching direction, the gate 64D is formed at a position that overlaps the stopper 562 of the nut 56. In other words, when viewed from the die matching direction, the gate 64 D is formed at a position that overlaps a region on the inside than the outer circumferential surface of the cylindrical section 561 of the nut 56.

Again, the description will refer to FIG. 3A. As illustrated in FIG. 3A, by die-matching the mold 62 and the mold 64, the cavity 60A is formed in the mold 60. In this state, as illustrated in FIG. 3B, a resin material is injected into the cavity 60A. The resin material is injected into the cavity 60A via the gate 64D. The injected resin material fills the inside of the cavity 60A.

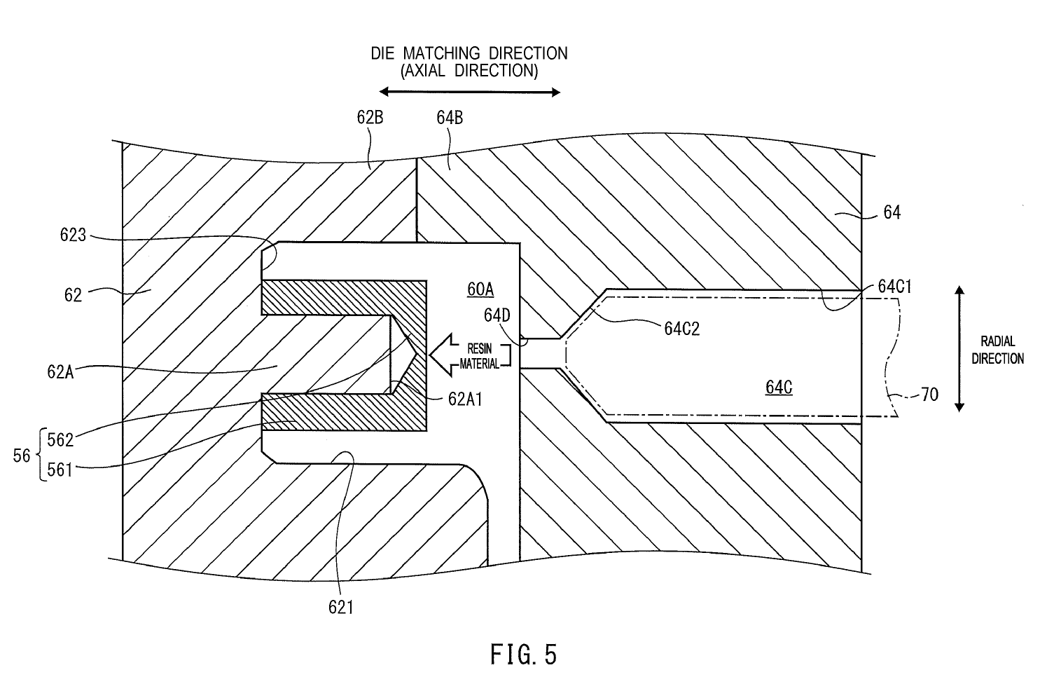

When being injected into the cavity 60A, the resin material strikes the stopper 562 of the nut 56 as illustrated in FIG. 5. The stopper 562 is pressed against the tip end surface of the protrusion 62A by a pressure when the resin material is injected. Therefore, it is possible to prevent the nut 56 from coming out of the protrusion 62A. In addition, the resin material which strikes the stopper 562 covers the axial end surface of the nut 56, then goes around radially to the outside of the nut 56, and covers the outer circumferential surface of the nut 56. In other words, the nut 56 can be prevented from moving in the radial direction with respect to the protrusion 62A. In this manner, by covering the axial end surface and the outer circumferential surface of the nut 56 with the resin material, the nut 56 can be positioned.

By solidifying the resin material injected into the cavity 60A, a cover 50 that serves as a molded product is obtained. After separating the mold 62 from the mold 64, the cover 50 is taken out from the mold 64 by using a plurality of ejector pins.

As illustrated in FIG. 1, the cover 50 is assembled to the hub unit 10 by inserting the cylindrical section 521 of the core bar 52 into the outer ring 12 of the hub unit 10. In this state, the sensor 40 for detecting the rotation of the inner shaft 14 is attached to the cover 50. Specifically, the sensor 40 is inserted into the insertion hole 543 formed in the cover 50. The attachment portion 40A provided in the sensor 40 overlaps the end surface of the attachment portion 542 and is fixed to the attachment portion 542 of the cover 50 by a bolt 42 inserted into the nut 56.

In the above-described production method, the nut 56 is positioned using the pressure at the time when the resin material is injected. Therefore, the structure of the mold 64 can be simplified, compared with a case where the pin which is capable of advancing and retracting with respect to the nut 56 is disposed on the mold 64 and the nut 56 is pushed by the pin.

In the above-described production method, the gate 64D is positioned coaxially to the nut 56. Therefore, when the nut 56 is pressed against the protrusion 62A with the resin material injected from the gate 64D, the nut 56 becomes difficult to be shaken in the radial direction of the cylindrical section 561. As a result, it is possible to prevent the resin material from being solidified in a state where the nut 56 is inclined with respect to the protrusion 62A.

### Application Example of Nut

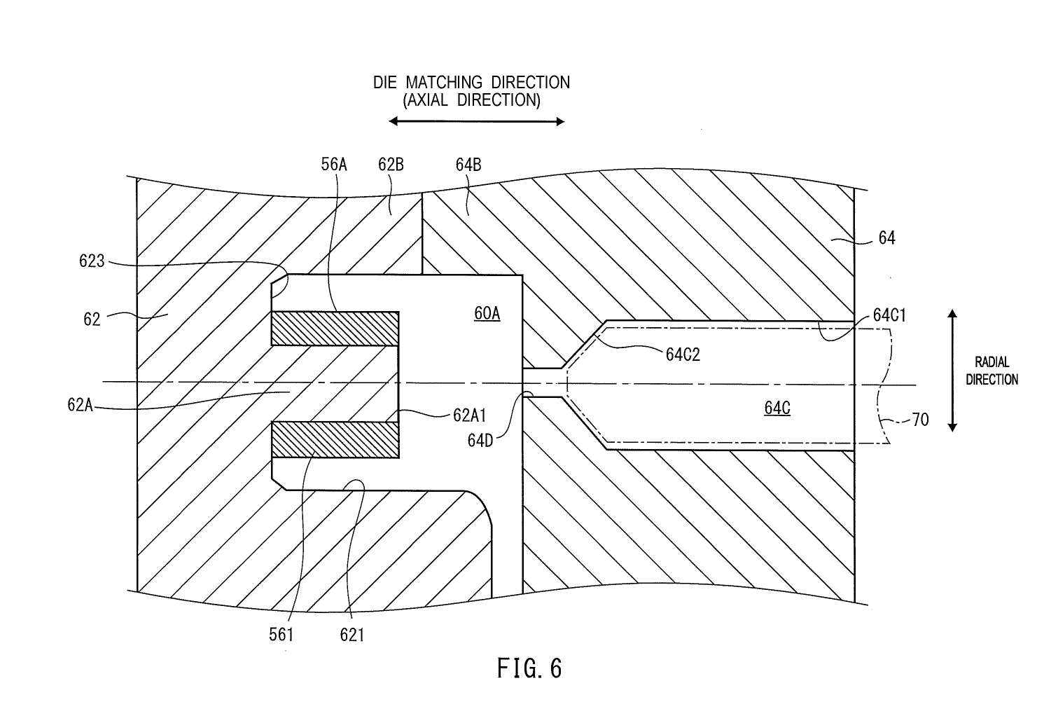

In the above-described embodiment, the nut 56 is provided with the stopper 562, but the stopper 562 may not be provided. FIG. 6 illustrates a state where a nut 56A which is not provided with the stopper 562 is disposed in the mold 60. In this case, the resin material injected from the gate 64D strikes the tip end surface of the protrusion 62A. Due to the pressure at the time of injection, the resin material which strikes the tip end surface of the protrusion 62A expands in the radial direction of the protrusion 62A. As a result, the axial end surface (the right end surface in FIG. 6) of the cylindrical section 561 of the nut 56A is covered with the resin material. In other words, it is possible to prevent the nut 56A from coming out of the protrusion 62A. In addition, the resin material which covers the axial end surface of the cylindrical section 561, then goes around to the outside in the radial direction of the cylindrical section 561 and covers the outer circumferential surface of the cylindrical section 561. In other words, the nut 56A can be prevented from moving in the radial direction of the cylindrical section 561 with respect to the protrusion 62A. In this manner, by covering the axial end surface and the outer circumferential surface of the cylindrical section 561 with the resin material, the nut 56A can be positioned.

In the case of using the nut 56A, a screw groove may be formed in advance on the inner circumferential surface of the cylindrical section 561. In this case, after taking out the molded article (cover) from the mold 60, a screw groove may be formed on the inner circumferential surface of the cylindrical section 561. In addition, in a case where the screw groove is formed in advance on the inner circumferential surface of the cylindrical section 561, after taking out the molded product (cover) from the mold 60, the resin which enters the screw groove may be scraped off.

In a case of using the nut 56A, the gate 64D may not be positioned coaxially to the protrusion 62A. For example, the gate 64D may be formed at a position which overlaps the axial end surface of the cylindrical section 561 when viewed from the die matching direction. In this case, the resin material injected from the hot runner nozzle 70 can strike the nut 56A. As a result, the nut 56A can be more reliably positioned.

Although the embodiments of the present invention have been described in detail above, these are merely examples, and the present invention is not limited in any manner by the above-described embodiments.

For example, in the above-described embodiment, the gate 64D may not be positioned coaxially to the nut 56. At least a part of the gate 64D may be at a position which overlaps the nut 56 when viewed from the die matching direction of the mold 62 and the mold 64.

This application is based upon and claims the benefit of priority from Japanese Patent Application No. 2015-223008 filed Nov. 13, 2015, the entire contents of which are incorporated herein by reference.

### DESCRIPTION OF REFERENCE SIGN(S)

10: Hub unit
12: Outer ring
14: Inner shaft
50: Cover
56: Nut
60: Mold
60a: Cavity
62: Mold
62a: Protrusion
64: Mold
64d: Gate

1. A production method for a cover to be attached to an outer ring of a hub unit, comprising:
preparing a first mold comprising a protrusion which protrudes into a first recess portion that forms a part of a cavity to be filled with a resin material;
preparing a second mold comprising a gate which is opened into a second recess portion that forms another part of the cavity, and through which the resin material with which the cavity is filled passes;
supporting a nut by the protrusion;
die-matching the first mold and the second mold in a state where at least a part of the gate overlaps an inside of the nut as compared with an outer circumferential surface of the nut when viewed from an axial direction of the nut; and
injecting a resin material into the cavity which is formed in a state where the first mold and the second mold are die-matched.

2. The production method for a cover according to claim 1,
wherein the nut comprises:
a cylindrical section into which a bolt is inserted; and
a stopper which covers an opening on one axial end of the cylindrical section and regulates an insertion amount of the bolt.

3. The production method for a cover according to claim 2,
wherein an opening of the gate to the cavity overlaps the stopper when viewed from the axial direction.

4. The production method for a cover according to claim 3,
wherein the opening of the gate to the cavity entirely overlaps the stopper when viewed from the axial direction.

5. The production method for a cover according to claim 1,
wherein a center of the opening of the gate to the cavity is positioned on a central axis of the cylindrical section when viewed from the axial direction.
